(19) United States
(12) Patent Application Publication
(10) Pub. No.: US 2007/0087117 A1
(43) Pub. Date: Apr. 19, 2007

(54) Process for protecting openings in a component during a treatment process, preventing penetration of material, and a ceramic material

(76) Inventors: Rene Jabado, Berlin (DE); Daniel Kortvelyessy, Berlin (DE); Ralph Reiche, Berlin (DE); Michael Rindler, Schoneiche bei Berlin (DE); Steffen Walter, Oberpframmern (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/542,545

(22) Filed: Oct. 3, 2006

(30) Foreign Application Priority Data
Oct. 4, 2005 (EP) 05021593.8

(51) Int. Cl. C09D 4/00; B05D 1/32

(52) U.S. Cl. 427/97.7; 427/282; 427/384; 106/287.16; 106/287.13; 106/287.1; 106/285

(57) ABSTRACT

In the process according to the invention for protecting openings in a component made from an electrically conductive base material, in particular from metal or from a metal alloy, during a treatment process, preventing penetration of material, prior to the treatment process the openings are closed up using a filling material which is removed again following the treatment process. The process according to the invention is distinguished by the fact that chains of Si—O—Si and/or Si—O—C are used as filling material.

### CROSS REFERENCE TO RELATED APPLICATIONS

This application claims the benefits of European Patent application No. 05021593.8 filed Oct. 4, 2005. All of the applications are incorporated by reference herein in their entirety.

### FIELD OF THE INVENTION

The present invention relates to a process for protecting openings in a component during a treatment process to prevent penetration of material, in which prior to the treatment process the openings are closed up using a filling material. The invention also relates to a ceramic material, in particular for use as filling material in the process according to the invention.

BACKGROUND OF THE INVENTION

Components which are subject to high thermal stresses, for example turbine blades or vanes of gas turbines, are frequently covered with a cooling film for cooling purposes. For this purpose, these components comprise cooling-fluid ducts which are arranged in the interior and transport a cooling fluid used to build up the cooling film. There are openings in the component, designed for example as cooling-air bores, to discharge the cooling fluid, for example air, from the interior of the component so that it can form the cooling film. These openings allow the cooling fluid to pass out from the interior of the component. The cross-sectional area and shape of the openings are designed in such a way that firstly the required quantity of cooling fluid flows out of the component and secondly a suitable cooling-fluid film is formed on the component surface.

The highly thermally stressed components described are also provided with coatings, for example with an MCrAlX coating, i.e. a coating which comprises chromium (Cr), aluminum (Al), yttrium (X═Y) and a further metal (M). This coating serves to protect the components against oxidation and/or corrosion. Moreover, the components may be coated with a thermally insulating coating, referred to below as the TBC (Thermal Barrier Coating) for short, for thermal insulation purposes.

During operation of the components, the coating or coatings become(s) worm, often before the structural integrity of the component has deteriorated to such an extent that it is no longer capable of operation. Consequently, the components are recoated in order to allow them to continue to be used. However, it may also be necessary to recoat the components if the component is merely to be tested, for example for structural defects, specifically if all the coatings have to be removed in order to test the component. During recoating, the problem arises that cooling-air bores are closed up or at least have their diameter reduced by the coating material, for example MCrAlX. The reduction in the diameter in turn reduces the outlet area of the opening, thereby changing and possibly reducing the cooling action provided by the cooling film. Moreover, if the outlet area of the opening becomes too small, the flow required for the cooling action, which is for example laminar or turbulent, may no longer be ensured. In both cases, this leads to premature failure of the component as a result of overheating. The reduction in the diameter of the openings is also known as the “coat-down effect”.

One way of counteracting the coat-down effect consists in the coating on the inside of the opening, which leads to a reduction in the diameter of the opening after recoating, being removed manually, for example by means of a diamond file, or using a laser. During the coating operation, quartz pins are sometimes also inserted into cooling-air bores, and these pins then have to be washed out again by means of an acid or an alkali. The literature also describes reopening cooling-air bores by means of EDM or fluid grinding.

Furthermore, there are known processes in which cooling-air bores of gas turbine. components, prior to the coating operation, are closed up by means of a masking material which is introduced into the cooling-air bores. Then, the material is left to harden. The coating process is carried out with the cooling-air bores protected in this way. Then, the masking material is removed again. By way of example, U.S. Pat. No. 5,902,647 and EP 1 076 106 describe processes in which the masking material is introduced into the holes in such a manner that it protrudes beyond the outer surface of the turbine component. In this case, however, it is difficult to ensure that the masking material does not extend laterally beyond the edge of the hole, in order to ensure that after the recoating operation the coating does actually reach all the way to the edge of the hole.

U.S. Pat. No. 4,726,104 also describes a process in which a masking is introduced into cooling-air bores.

U.S. Pat. No. 3,099,578 discloses an electrically conducting composition comprising carbon and silver which are mixed with one another in a resin.

JP 2003342707 discloses a process for coating an outer surface, holes which are filled with a mixture of a metallic material and a resin being present in the outer surface.

JP 2003306760 likewise discloses a process for masking holes, which in this case are protected by a carbon-coated metallic rod.

WO03/089679 describes a process in which the masking material is introduced into the cooling-air bores in a turbine blade or vane in such a manner that its surface ends flush with the surface of the turbine component. Suitable selection of the masking material and of filling materials in the masking material ensures that the coating material does not stick to the masking material. In this case, a two-stage process is used to close up the cooling-air bore. First of all, a deformable mass is introduced, which then has to be hardened in a second step.

Moreover, the polymers which are part of the filling material leave streaks of soot on the component when they are burnt out.

### SUMMARY OF THE INVENTION

It is an object of the present invention to provide a process for protecting openings in a component against penetration of coating material during a coating process which represents an improvement on the prior art.

It is a further object of the present invention to provide a ceramic material which has advantageous properties and is particularly suitable for use in the process according to the invention.

The first object is achieved by the process, and the second object by the ceramic material as claimed in the claims.

The dependent claims give advantageous configurations of the process and the ceramic material and can be advantageously combined with one another as desired.

In the process according to the invention for protecting openings in a component from penetration of material during a treatment process, prior to the treatment process the openings are closed up using a filling material which is removed again following the treatment process. Treatment processes in question are in particular coating processes and soldering processes.

The process according to the invention is distinguished by the fact that the filling material comprises Si—O—C chains or Si—O—Si chains, preferably of polysiloxane, as at least one filler.

It is particularly advantageous if the filling material used is a filling material whose conductivity corresponds to that of the base material, i.e. up to 50% of the electrical conductivity of the base material.

The advantage of the process according to the invention over the previous processes is that the treatment process is not adversely affected to such an extent by the filling material. By way of example, during an MCrAlX coating process, what is known as cleaning sputtering takes place, in which the component is exposed to an arc. On account of the conductivity of the filling material being matched to the base material, the arc is not adversely affected to any significant extent at the transitions between the surface of the base material and the surface of the filling material. Any such adverse effect could lead to damage to the component. Many treatment processes, for example processes for coating the MCrAlX, also comprise at least one heating process. On account of the conductivity of the filling material being matched to the base material, the introduction of heat into the component is not disrupted at the transitions between the base material and the filling material.

The filling material used is preferably a hardenable filling material, in particular a ceramic filling material, in order to increase the strength and stability of the filling material introduced into the openings during the treatment process. The hardening takes place after the openings have been filled with the filling material. If the hardenable filling material is a ceramic filling material, by way of example a coating material that is to be applied during a coating process will not stick to the filling material, or will do so only to a limited extent, on account of the ceramic properties of the filling material. This applies in particular to MCrAlX coatings.

The hardening of the filling material can be achieved by a suitable heat treatment. The heat treatment can advantageously be realized by a heat treatment carried out as part of the treatment process or can be integrated in a heat treatment of this type, with the result that there is no need for an additional heat treatment step.

The hardenable filling material can be introduced into at least some of the openings in particular in the form of a paste. The introduction of the paste, which can be effected for example by means of a spatula apparatus, offers the advantage that holes of any desired shape can be filled in this way.

However, as an alternative or in addition, it is also possible for preshaped, at least partially crosslinked filling bodies or filling bodies which require no further heat treatment and for example adhere mechanically in the cooling-air bores to be introduced into at least some of the openings.

Partially crosslinked filling bodies are filling bodies which comprise a polymer-based binder which has a partially crosslinked polymer architecture. A partially crosslinked state is also known as the “green state” and offers a higher dimensional stability compared to a paste, so that the material can maintain a physical form even prior to the hardening. Filling openings by means of partially crosslinked filling bodies of this type is especially suitable for introducing the filling material into large openings, as may occur for example in the region of the base of turbine blades or vanes. Moreover, it is also possible for the entire area of curved component surfaces to be protected by means of partially crosslinked filling bodies, for example if the partially crosslinked filling bodies are in the form of tapes or sheets.

The materials properties of the hardenable filling material and/or the hardening conditions can be selected in such a manner that the filling material is only partially hardened. If the materials properties and/or the hardening conditions are selected in such a way that the filling material hardens only in the region of the contact zones with the base material of the component but is only partially crosslinked or remains partially crosslinked in the volume of the filling material, it is possible for the filling material to be removed after the treatment process by means of a suitable blasting process, in particular by means of a CO₂ blasting process. In a blasting process, a suitable material, for example CO₂ (carbon dioxide) in the form of dry ice, is blown onto the component under pressure in order to remove the filling material from the openings. Removing the filling material by means of dry ice blasting has no detrimental effect for example on an MCrAlX coating; Moreover, there is no possibility. whatsoever of the beta phase of an MCrAlX coating being “washed out” when the filling material is being removed by means of dry ice blasting.

A ceramic material according to the invention, which can be used in particular as filling material in the process according to the invention, contains chains of Si—O—Si and/or Si—O—C.

The conductivity of the hardened ceramic material according to the invention can be set in a controlled way by using a suitable composition of the binder and filler, in particular by suitably selecting the electrically conductive component. In this way, the material offers the option of matching its conductivity to the conductivity of the base material of the component into whose openings it is to be introduced. The ceramic properties of the material ensure that any coatings exhibit poor adhesion to the surface of the hardenable material, making it suitable in particular for use in the process according to the invention.

The ceramic material according to the invention may in particular comprise a carbon precursor as binder. In this case, the carbon of the carbon precursor can produce the conductivity after hardening. There is then no need to add any metal powder to the filler.

Alternatively, it is also possible for the filler to comprise a metal powder as electrically conductive component which produces the electrical conductivity.

The ceramic material may comprise a solvent for producing a dispersion of the binder and the filler. The use of the solvent makes it possible to form a ceramic material that is able to flow prior to being hardened, thereby allowing the material to be spread or sprayed into openings. Examples of suitable solvents include alcohol or terpeneol.

In an advantageous refinement of the ceramic material, the filler comprises particles in at least two particle sizes, the particle sizes in particular being in the nanometer range (in particular less than 0.1 μm) and/or the micrometer range. The filler content in the ceramic material can be increased by using particles of different sizes.

### BRIEF DESCRIPTION OF THE DRAWINGS

Further features, properties and advantages of the present invention will emerge from the following description of an exemplary embodiment with reference to the accompanying drawings, in which:

FIG. 1 shows a diagrammatic illustration of an excerpt from a turbine blade or vane with cooling-air bores,

FIG. 2 shows a first example of the introduction of the hardenable material according to the invention into the cooling-air bores of turbine blades or vanes,

FIG. 3 shows a second example of the introduction of the hardenable material according to the invention into the cooling-air bores of turbine blades or vanes,

FIG. 4 shows a perspective view of a turbine blade or vane,

FIG. 5 shows a perspective view of a combustion chamber, and

FIG. 6 shows a turbine.

### DETAILED DESCRIPTION OF THE INVENTION

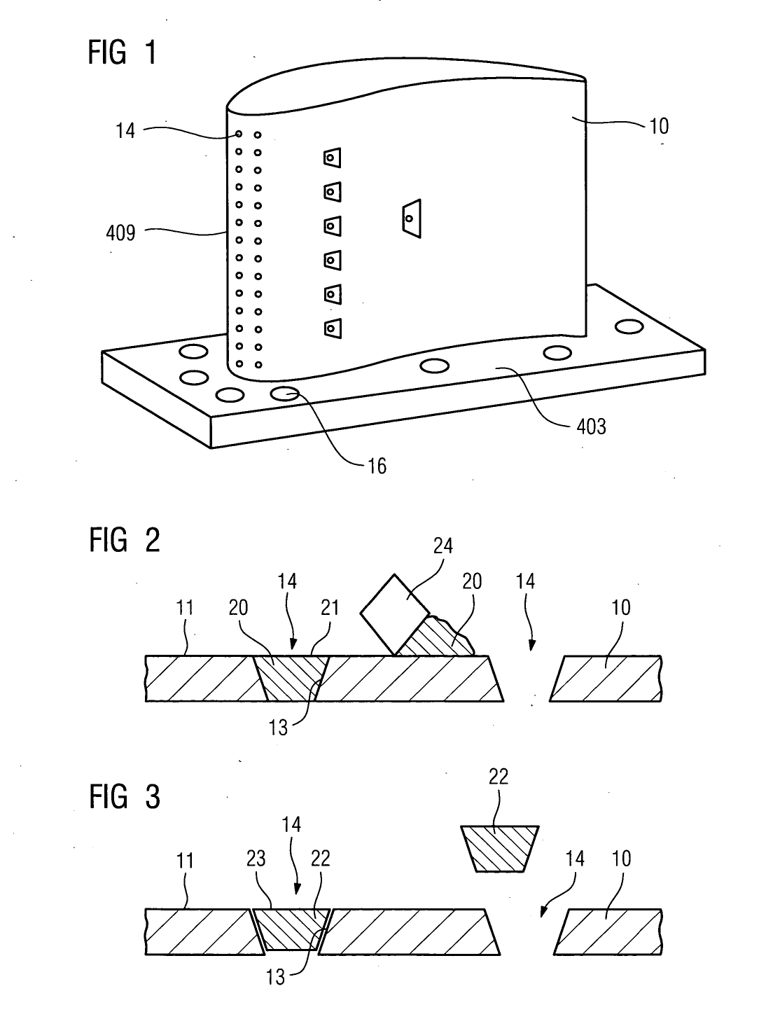

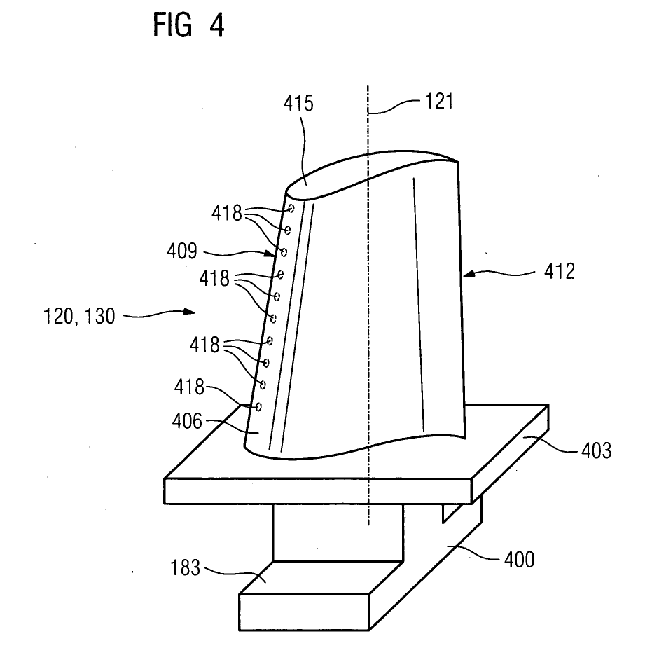

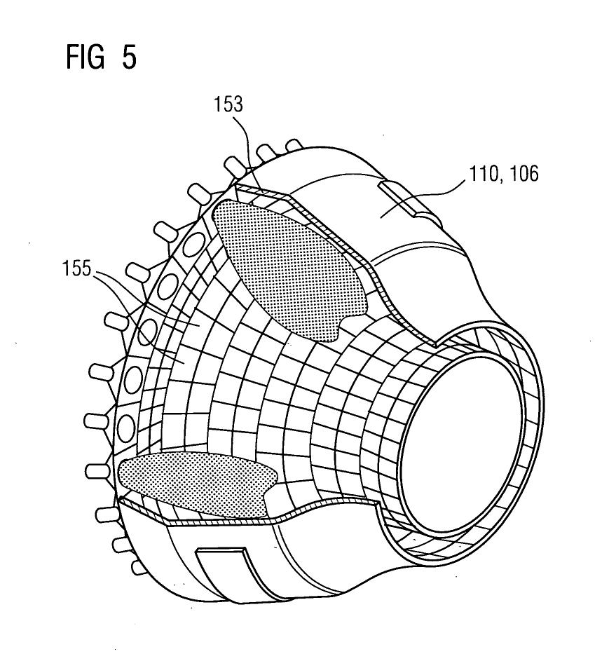

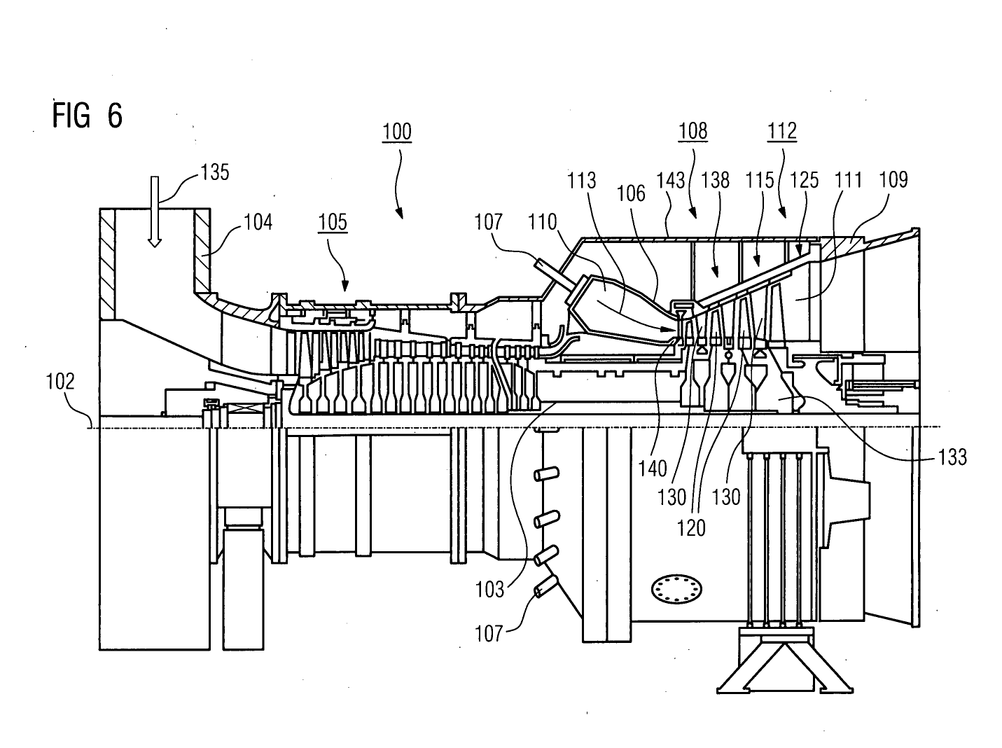

FIG. 1 diagrammatically depicts an excerpt from a turbine blade or vane 10, 120, 130 (FIGS. 4, 6). The following explanations also apply to other components which have holes, such as for example heat shield elements 155 (FIG. 5).

The turbine blade or vane 10 is joined to a baseplate 403 and has a number of cooling-air openings 14, of which in the present illustration only those which are located in the region of the leading edge 409 of the turbine blade or vane 10 are illustrated. Like the turbine blade or vane 10, the baseplate 403 has cooling-air openings 16, the diameter of which, in the present example, is larger than the diameter of the cooling-air openings 14 in the turbine blade or vane 10.

The cooling fluid, generally cooling air, is fed to the cooling-air openings 14 in the turbine blade or vane through cooling-air ducts, which are not illustrated and are arranged in the interior of the turbine blade or vane 10.

The turbine blade or vane 10 and the baseplate 403 are provided with a coating protecting against oxidation and/or corrosion. An example of a suitable coating is an MCrAlX coating. A further coating may be present above this coating, as a thermal barrier (TBC) for thermal insulation purposes.

When these coatings have become worn or during certain maintenance work, the coatings are removed from the turbine blade or vane. This is followed by the application of a new coating.

Prior to the application of the new coating, the cleaning-air openings 14 and 16 are closed up using a filling material 20, 22 in order to prevent the openings 14, 16 being filled with coating material during coating, thereby reducing the effective cross section of flow of the openings.

The filling material 20, 22 with which the openings are closed off is a hardenable material which in the hardened state has a conductivity which substantially corresponds to that of the base material of the turbine blade or vane 10.

The composition of the hardenable material is described below.

In the present exemplary embodiment, the hardenable material is a ceramic material which comprises chains of Si—O—C and/or Si—O—Si, preferably chains of polysiloxane, and which preferably also comprises at least one binder and at least one filler.

The binder and/or the filler comprise(s) at least one electrically conductive component. If appropriate, it is also possible for a plurality of electrically conductive components to be present.

Suitable electrically conductive components are carbon and/or metal powder.

Suitable binders include inorganic and/or organic binders or organosilicon binders, for example siloxanes or silicones.

Possible compositions of the ceramic material are shown in Table 1.

TABLE 1

| C1 Paste | C2 Paste | Polysiloxane | Metal |
|---|---|---|---|
| % by volume | % by volume | % by volume | % by volume |
| 90 | 0 | 10 | 0 |
| 0 | 80 | 20 | 0 |
| 45 | 45 | 10 | 0 |
| 30 | 30 | 20 | 20 |
| 70 | 0 | 10 | 20 |
| 0 | 0 | 70 | 30 |

C1 = for example graphite as electrically conductive material (particle diameter: approx. 1 μm, graphite/binder mixture in % by volume: 65 graphite/35 binder)
C2 = for example graphite as electrically conductive material (particle diameter: approx. 11 μm, graphite/binder mixture in % by volume: 65 graphite/35 binder)
Me: Metal or metal alloy of the base material (particle diameter: approx. 25 μm)

Further possible compositions of the ceramic material are shown in Table 2.

TABLE 2

| C3 Paste | C4 Paste | Polysiloxane | Metal |
|---|---|---|---|
| % by volume | % by volume | % by volume | % by volume |
| 90 | 0 | 10 | 0 |
| 0 | 80 | 20 | 0 |
| 45 | 45 | 10 | 0 |
| 25 | 35 | 20 | 20 |
| 70 | 0 | 10 | 20 |
| 0 | 0 | 80 | 20 |

C3 = for example graphite as electrically conductive material (particle diameter: approx. 0.1 μm, graphite/binder mixture in % by volume: 65 graphite/35 binder)
C4 = for example graphite as electrically conductive material (particle diameter: approx. 5.5 μm, graphite/binder mixture in % by volume: 65 graphite/35 binder)
Me: Metal or metal alloy of the base material (particle diameter: approx. 15 μm)

In addition to the binder, the ceramic material may also comprise a solvent, for example an alcohol-based or terpeneol-based solvent, in order to produce a dispersion of the binder and filling material which is able to flow. The viscosity of the dispersion can be influenced by the type and quantity of solvent. For example a higher solvent content increases the viscosity of the dispersion. The fillers form between 20 and 60% by volume.

The carbon and/or the metal powder may in particular have particles with different diameters in the nanometer and/or micrometer range (less than 500μm). It is preferable for there to be at least two particle sizes, in which case for example the carbon has a different article size than the metal powder. However, it is also possible for the carbon alone or metal powder alone to be present in two particle sizes. Examples of materials in which two or more particle sizes are present are likewise to be found in Table 1 or 2.

The particle diameters are important with regard to the compacting properties of the material, the pore distribution of the material after crosslinking and the reactivity of the material with the gas phase. By way of example, a high degree of compacting of the material can be achieved with a higher number of different particle diameters than with just a single particle diameter.

The coefficient of thermal expansion of the ceramic material can be varied by the type of filler, in particular the metal powder content in the filler. An excessively high metal content, however, can lead to excessive bonding of the ceramic material to the base material of the turbine blade or vane, making it difficult to remove the ceramic material after the coating operation. The bonding of the ceramic material to the substrate is influenced not only by the metal content but also by the temperature used during the heat treatment for hardening the ceramic material. In this context, a higher temperature leads to greater adhesion of the ceramic material, in particular the metal fractions of the ceramic material, to the base material. The compacting properties of the ceramic material are also dependent on the temperature used during hardening. Finally, the carbon and/or metal content of the filler material also influences the electrical conductivity of the ceramic material and therefore also its thermal conductivity. The carbon and/or metal content in the filler will generally be selected in such a way that the electrical conductivity and/or the coefficient of thermal expansion of the ceramic material does/do not deviate excessively from the corresponding values for the base material of the turbine blade or vane. This can be achieved for example by the metal or metal alloy of the base material being selected as a metal component of the filler. When selecting the quantity of metal powder added, it should be ensured, as has already been mentioned above, that the ceramic material is not excessively intimately joined to the base material during hardening, since this would make it more difficult to remove the filler following the coating process.

The introduction of the ceramic material into the openings 14 in the turbine blade or vane 10 is illustrated in FIGS. 2 and 3.

In the process illustrated in FIG. 2 for introducing the ceramic material 20, the ceramic material 20 is in the form of a paste. The compound is spread into the openings 14 by means of a spatula-like apparatus 24, so that the surface 21 of the ceramic materials 20, after it has been spread into the openings, ends flush with the surface 11 of the turbine blade or vane 10, i.e. does not project above the surface 11 of the turbine blade or vane. It is also possible for the paste to be sprayed into the openings rather than spread.

An alternative way of introducing the ceramic material is illustrated in FIG. 3.

This alternative is suitable in particular for introducing the ceramic material into openings 16 with a relatively large diameter; as can be found for example in the base plate 12. According to the second variant, the ceramic material is introduced into the openings in the partially crosslinked state, also known as the green state, in the form of shaped bodies.

It is also possible to use a shaped body which cannot be hardened any further.

A shaped body may be designed in the form of a pin, button, peg, etc. It is inserted in such a way that its surface 23 ends flush with the surface 11 of the turbine blade or vane 10. In particular, it is possible to match the shaped body to the cross section of the opening that is to be filled.

The shaped body can for example be stamped out of a sheet consisting of the ceramic material in the green state. Sheets or tapes of the ceramic material in the green state can also be used to protect large-area portions of the turbine blade or vane during the coating operation.

According to the invention, the filling material consists either of Si—O—Si chains (ceramicization in air) and/or of Si—O—C chains (ceramicization in argon, vacuum). The Si—O—C chains or Si—O—Si chains are preferably produced from a polysiloxane resin. Polysiloxane resins are polymer-ceramic precursors of the structural formula XSiO_{1.5}, where X may be —CH₃, —CH, —CH₂, -C₆H₅, etc. The material is thermally crosslinked, with inorganic constituents (Si—O—Si chains) and organic side chains predominantly comprising X being present together. Then, the precursors are ceramicized by means of a heat treatment in Ar, N₂, air or vacuum atmosphere at temperatures between 600° C. and 1200° C. The polymeric network is decomposed and restructured via thermal intermediate stages from amorphous to crystalline phases, with an Si—O—C network being formed form polysiloxane precursors.

It is preferably also possible to use a mixture of Si—O—C chains and Si—O—Si chains.

It is also possible to use precursors of the polysilane (Si—Si), polycarbosilane (Si—C), polysilazane (Si—N) or polybarosilazane (Si—B-C-N) type.

If the ceramic material is spread or sprayed into the openings in the form of a paste, the polymer constituents, i.e. for example the inorganic and/or organic binder or the organosilicon binder, are then crosslinked by means of a heating step, which takes place at temperatures of approximately 200° C., in order to produce a preliminary dimensional stability of the ceramic material before the coating process is carried out.

If, as illustrated in FIG. 3, the ceramic material is used in the form of a green shaped body, the ceramic material must previously have been crosslinked or at least partially crosslinked in order to ensure the dimensional stability of the shaped body even before it is inserted into the openings. The (partial) crosslinking is in this case effected by a suitable heat treatment at temperatures of no more than approx. 200° C., in which the inorganic and/or organic binder or the organosilicon binder adopts an at least partially crosslinked polymer architecture.

As the process continues, the material which has been introduced into the openings is pyrolitically converted (fired or ceramicized) at temperatures above approx. 400 to 450° C., in order to effect the ceramicization of the material. This firing operation can be integrated into the coating process. By way of example, a coating process for applying an MCrAlX coating comprises a preheating operation, in which the abovementioned temperatures are reached or exceeded.

The firing also compacts the ceramic material. Moreover, pores are formed in the material, with an open or closed porosity.

The compacting properties and the pore distribution in the hardened material depend firstly on the choice of binder, for example on the carbon concentration in the binder, and secondly on the particle diameters of the filler. When selecting the binder and suitable particle diameters for the filler, it should be ensured that the resulting pores ensure a sufficient stability of the hardened material and are not so large that the coating material reaches the walls of the openings through the pores.

Depending on the type of binder used and the type of ceramic to be produced, the firing operation takes place either under the exclusion of air, for example in an inert gas atmosphere, or in an air atmosphere.

If a carbon-based binder based on an organic binder is used, the firing operation takes place under the exclusion of air, so that the carbon is not oxidized to form CO or CO₂. In the case of the firing process taking place under inert gas, up to 90% of the carbon remains in the material. If the filler comprises metal powder, metal carbide phases may form. Some metal carbides, for example aluminum carbide, offer the possibility of the hardened ceramic material being flushed out of the openings by means of water after the coating process has ended, since they react with water and are soluble therein. It is also possible to select metals which do not form carbides at the coating or treatment temperatures.

If organosilicon binders, such as siloxanes or silicones, are used, the firing may produce silicon carbide phases (in the case of firing under the exclusion of air) or silicon oxide phases (in the case of firing in air). The composition of the atmosphere under which the firing operation is carried out and the composition of the organosilicon binder can be used to set the level of oxide phases in relation to carbide phases following the firing operation.

During the firing, it is possible to set the level of silicon oxide in the ceramic material in a continuously variable manner within the range between 0% and 100% following the firing operation. 0% silicon oxide can be achieved for example by using inorganic and/or organic binders as the binder.

The composition of the binder, the composition of the filling material and also the temperature and duration of the firing operation for the ceramic material according to the invention can be selected in such a manner that this material is fully hardened only in the region of its surface or its contact face 13 with the metal. In the interior of its volume, the ceramic material is then in an unhardened, crosslinked or partially crosslinked state. This facilitates removal of the ceramic material by means of a blasting process following the coating operation.

The ceramic material can be removed from the openings by means of dry ice blasting if its composition and the hardening conditions have been selected appropriately. Removing it by means of dry ice blasting by way of example has no adverse effect on metallic MCrAlX coatings. Moreover, there is no possibility whatsoever of the beta phase of the MCrAlX coating being “washed out”.

The ceramic material according to the invention may if appropriate also comprise traces, i.e. levels by volume of less than approx. 1%, of additives. Suitable additives include for example catalysts which promote crosslinking of the binder at temperatures below approx. 200° C. A catalyst of this type used may for example be platinum. Additives for influencing the surface tension of the solvent and therefore for targeted substrate bonding are also conceivable.

In the exemplary embodiment, the process according to the invention for protecting openings in a component made from a metal-based base material against penetration of coating material during recoating of the component is described. However, the process can also be advantageously used for initial coating, if openings that are to be protected are already present in the component prior to the initial coating.

Another recommended application area for the ceramic material according to the invention is in soldering processes. For example, during the soldering of turbine blades or vanes, what are known as stop-offs are used to protect cooling-air bores from the penetration of solder. The ceramic material according to the invention can advantageously be used to protect the cooling-air bores instead of the stop-offs. After the soldering, the ceramic material does not need to be removed from the openings and can remain therein for a subsequent coating process. This makes it possible to save on process steps and to reduce throughput times.

FIG. 4 shows a perspective view of a rotor blade 120 or guide vane 130 of a turbomachine 100, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400. The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade. or vane 120, 130.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloy. The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1; these documents form part of the disclosure.

The blades or vanes 120, 130 may likewise have coatings protecting against corrosion or oxidation (MCrAlX; M is at least one element selected from the group consisting of iron (Fe), cobalt (Co), nickel (Ni), X is an active element and represents yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of the present disclosure with regard to the chemical composition of the alloy.

It is also possible for a thermal barrier coating, consisting for example of ZrO₂, Y₂O₃—ZrO₂, i.e. unstabilized, partially stabilized or completely stabilized by yttrium oxide and/or calcium oxide and/or magnesium oxide, to be present on the MCrAlX.

Columnar grains are produced in the thermal barrier coating by means of suitable coating processes, such as for example electron beam physical vapor deposition (EB-PVD), or porous grains with micro-cracks and macro-cracks are produced in the thermal barrier coating for example by atmospheric plasma spraying (APS).

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused, wherein the process according to the invention is employed.

The blade or vane 120, 130 may be hollow or solid in form. If the blade or vane 120, 130 is to be cooled, it is hollow and may also have film-cooling holes 418 (indicated by dashed lines).

FIG. 5 shows a combustion chamber 110 of a gas turbine 100. The combustion chamber 110 is configured, for example, as what is known as an annular combustion chamber, in which a multiplicity of burners 107 arranged circumferentially around the axis of rotation 102 open out into a common combustion chamber space 154, which generate flames 156. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000C. to 1600° C. To allow a relatively long service life even with these operating parameters, which are unfavorable for the materials, the combustion chamber wall 153 is provided, on its side which faces the working medium M, with an inner lining formed from heat shield elements 155.

Each heat shield element 155 made from an alloy is provided on the working medium side with a particularly heat-resistant protective coating (MCrAlX layer and/or ceramic coating) or is made from high-temperature-resistant material (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and represents yttrium (Y) and/or silicon and/or at least one rare earth element, or hafnium (Hf). Alloys of this type are known from EP0486489B1, EP0786017B1, EP0412397B1 or EP1306454A1, which are intended to form part of the present disclosure with regard to the chemical composition.

It is also possible for example for a ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by means of suitable coating processes, such as for example electron beam physical vapor disposition (EB-PVD).

Refurbishment means that after they have been used, protective layers may have to be removed from heat shield elements 155 (e.g. by sand-blasting). Then, the corrosion and/or oxidation layers and products are removed. If appropriate, cracks in the heat shield element 155 are also repaired. This is followed by recoating of the heat shield elements 155, in which the process according to the invention is used, after which the heat shield elements 155 are reused.

A cooling system may also be provided for the heat shield elements 155 and/or their holding elements, on account of the high temperatures in the interior of the combustion chamber 110. The heat shield elements 155 are in this case for example hollow and if appropriate also have film-cooling holes (not shown) opening out into the combustion chamber space 154.

FIG. 6 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, torroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108. Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they have to be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloys.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

1-27. (canceled)

28. A process for protecting openings in a component during a treatment process so as to stop the penetration of material, comprising:
filling the openings of the component prior to the treatment process with a filling material comprising:
Si—O-C or Si—O-Si chains, and
carbon or metal; and
removing the filling material following the treatment process.

29. The process as claimed in claim 28, wherein carbon or metal is electrically conductive.

30. The process as claimed in claim 29, wherein the filling material comprises:
a binder, and
a filler comprising the carbon or metal where the filler electrical conductivity is up to 50% of the electrical conductivity of the base material.

31. The process as claimed in claim 30, wherein the binder comprises a carbon or a carbon precursor.

32. The process as claimed in claim 28, wherein the filling material comprises polysiloxane.

33. The process as claimed in claim 32, wherein the polysiloxane:
is a hardenable filling material, and
the hardening takes place after the openings have been filled with the filling material.

34. The process as claimed in claim 33, wherein:
the hardening occurs during a heat treatment that is integrated into the coating process.

35. The process as claimed in claim 33, wherein the material properties of the filling material and the hardening conditions are selected such that the filling material is partially hardened.

36. The process as claimed in claim 35, wherein the material properties of the filling material and the hardening conditions are selected such that complete hardening of the filling material occurs in a region of the filling material that contacts the component.

37. The process as claimed in claim 28, wherein the filling material is a paste.

38. The process as claimed in claim 28, wherein the filling material is a pre-shaped, partially crosslinked filling body.

39. The process as claimed in claim 28, wherein the filling material is removed by a blasting process.

40. The process as claimed in claim 28, wherein the treatment process is a coating process, a soldering process or a sputtering process.

41. A ceramic material for use as a protective filler material, comprising:
a binder; and
an electrically conductive filling material containing polysiloxane having Si—O-C or Si—O-Si chains.

42. The ceramic material as claimed in claim 41, wherein the binder is a carbon precursor.

43. The ceramic material as claimed in claim 41, wherein the filler comprises particles sized in the range from 0.01 μm to 100 μm.

44. The ceramic material as claimed in claim 41, wherein the ceramic material comprises electrically conductive components selected from the group consisting of: carbon, metal powder and a carbon precursor.

45. The ceramic material as claimed in claim 42, wherein an organosilicon binder is the carbon precursor.

46. The ceramic material as claimed in claim 41, further comprising an alcohol-based or terpeneol-based solvent to disperse the binder and the electrically conductive component.
